(19) United States
(12) Patent Application Publication
(10) Pub. No.: US 2003/0154392 A1
(43) Pub. Date: Aug. 14, 2003

(54) Secure system firmware using interrupt generation on attempts to modify shadow RAM attributes

(76) Inventor: Timothy A. Lewis, El Dorado Hills, CA (US)

Correspondence Address: Kimberley G Nobles, IRELL & MANELLA LLP, 840 Newport Center Drive, Suite 400, Newport Beach, CA, 92660, US

(21) Appl. No.: 10/073,616

(22) Filed: Feb. 11, 2002

(51) Int. Cl. G06F 9/445

(52) U.S. Cl. 713/200; 713/2

(57) ABSTRACT

A system, method and software that secures system firmware located in shadow RAM from unauthorized tampering. The present invention adds protection, either as a whole, or to individual portions of shadow RAM, using a configuration register in a memory controller (or other chip containing shadow RAM attribute control), or an external trapping chip, that traps accesses to a register or registers normally used to enable reading, writing and/or caching of the shadow RAM and generates an interrupt. Only resetting of the trapping chip unlocks the shadow RAM and allows modifications to reading, writing and/or caching of the shadow RAM area. Since trusted code gains control after reset, malicious or run-away programs cannot gain control while the shadow RAM is vulnerable. The entire shadow RAM area or individual shadow RAM areas may be controlled. The present invention permits use of code in the shadow RAM without fear of its alteration, raising reliability from run-away applications or malicious attack.

### BACKGROUND

The present invention relates generally to computer systems, and more particularly, to a system, method and software for securing system firmware located in shadow RAM from unauthorized tampering.

Currently, portions of system BIOS firmware are copied into a special memory space located below 1 megabyte known as shadow random access memory (RAM). The shadow RAM can be divided into smaller sections or regions, each of which can be controlled individually. These regions can have the readability, writeability or cacheability selectively turned on or off, which allows them to act as if actual ROM exists below 1 MB. A malicious program or virus could enable shadow RAM, change its contents and thus disrupt system behavior and cause loss of data.

A somewhat similar technology exists in the prior art for disabling write access to a portion of RAM known as system management RAM (SMRAM). By using this technology, copies of a large portion of the system firmware are placed in SMRAM. The SMRAM code then no longer makes calls back to the “shadow RAM” but rather to its copy. A “locking” bit, however, does not prevent writeability, rather it prevents SMRAM from appearing in any form (read, write, execute, etc.) to normal programs.

There also exists a similar prior art technology for trapping attempts to enable writeability to erasable non-volatile EEPROMs, such as flash memory. When such an attempt is made, an SMI is generated. Such technology is described in the “RS-I/O Controller Hub (ICH) External Design Specification” published by Intel Corporation.

There is also prior art relating to disabling writes to a given region of shadow RAM using configuration registers. One example known to the inventor is found in a model 430TX memory controller from Intel Corporation.

The following are disadvantages of the known prior art. The prior art has not made any attempt to protect the shadow RAM area of memory from malicious attack. The prior art, while protecting shadow RAM from spurious writes to the area, does not prevent malicious code from removing the write-protection from the area using configuration registers.

It is an objective of the present invention to provide for a system, method and software that secures system firmware located in shadow RAM from unauthorized tampering.

### SUMMARY OF THE INVENTION

To meet the above and other objectives, the present invention adds protection, either as a whole, or to individual portions of shadow RAM, using a configuration register in a memory controller (or other chip containing shadow RAM attribute control), or using an external chip, that traps accesses to a register or registers normally used to enable reading, writing and/or caching of the shadow RAM. A chip containing such a “trapping” mechanism is referred to as a “trapping chip”. [TIM] The trapping chip, once configured, detects attempts to write to the configuration register and generates an interrupt.

Only a reset of the trapping chip “unlocks” the shadow RAM and allows modifications to reading, writing and/or caching of the shadow RAM area. Various implementations may include control of the entire shadow RAM area or individual control for each shadow RAM region. The present invention thus allows usage of code in the shadow RAM without fear of its alteration, raising reliability from run-away applications or malicious attack.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates a portion of an exemplary computer system in accordance with the principles of the present invention for securing system firmware located in shadow RAM;

FIG. 2 illustrates exemplary system firmware or BIOS used in the computer system shown in FIG. 1; and

FIG. 3 is a flow diagram that illustrate an exemplary method in accordance with the principles of the present invention for securing system firmware located in shadow RAM.

### DETAILED DESCRIPTION

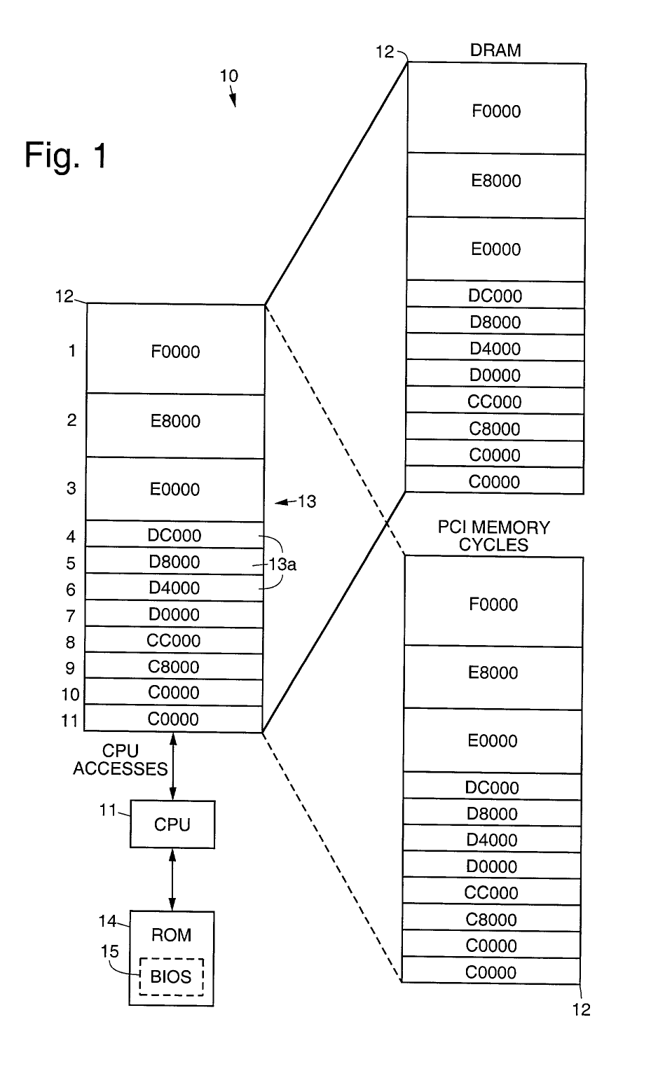

Referring to the drawing figures, FIG. 1 illustrates a portion of an exemplary system 10 in accordance with the principles of the present invention. The system 10 comprises a CPU 11 that is coupled to dynamic random access memory (DRAM) 12. A portion of the dynamic random access memory (DRAM) 12 is configured as shadow random access memory (RAM) 13. The shadow RAM 13 comprises one or more shadow RAM areas 13a, or registers 13a, whose attributes are separately configurable.

In personal computers, code used to control hardware devices, such as keyboards, for example, is normally executed in a system firmware (BIOS) read only memory (ROM) 14 (or ROM chip). However, the BIOS ROM 14 is slower than general-purpose RAM 12 that comprises main memory of the personal computer. The use of high-speed RAM memory in the form of the shadow RAM 13 in place of slower BIOS ROM 14 increases the operational speed of a computer.

The system firmware 15 or BIOS 15 initially stored in the BIOS read only memory 14 is transferred into the shadow random access memory 13 during booting of the operating system. The present system 10 is operative to secure the system firmware 15 located in the shadow RAM 13 and thus prevent unauthorized tampering.

The shadow RAM 13 permits memory accesses by the CPU 11 to either continue on to bus devices, or, based on a configurable option, access the dynamic random access memory (DRAM) 12. The access to DRAM 12 may be read-only, read-write, write-only (in some hardware configurations) and pass-through (no effect). Other options may be provided.

The shadow RAM 13 is divided into eleven regions as is illustrated in FIG. 1. For each of the eleven regions of the shadow RAM 13, there are three bits (attributes) that control CPU access and one bit that controls access to the other three bits. These bits are as follows:

[0]: 0=CPU reads from PCI memory space

1=CPU reads from DRAM

[1]: 0=CPU writes to PCI memory space

1=CPU writes to DRAM

[2]: 0=CPU reads/writes not cached

1=CPU reads/writes cached

The control bit is defined as:

[3]: 0=bits 0:2 are read/write

1=Writes to bits 0:2 do not change them. Instead they generate an interrupt or SMI.

Once written to 1, this bit (bit 3) can only be cleared by resetting of the computer system, or, in an alternative form of the present invention, while the computer system is operating in system management mode (SMM), for example.

In addition, one other register determines the type of interrupt to be generated when a write to a protected bit is detected. For example,

FD=SMI,

FE=NMI,

FF=no interrupt generated but write is still ignored, and

00-EF=IRQx (where x is 00-EF).

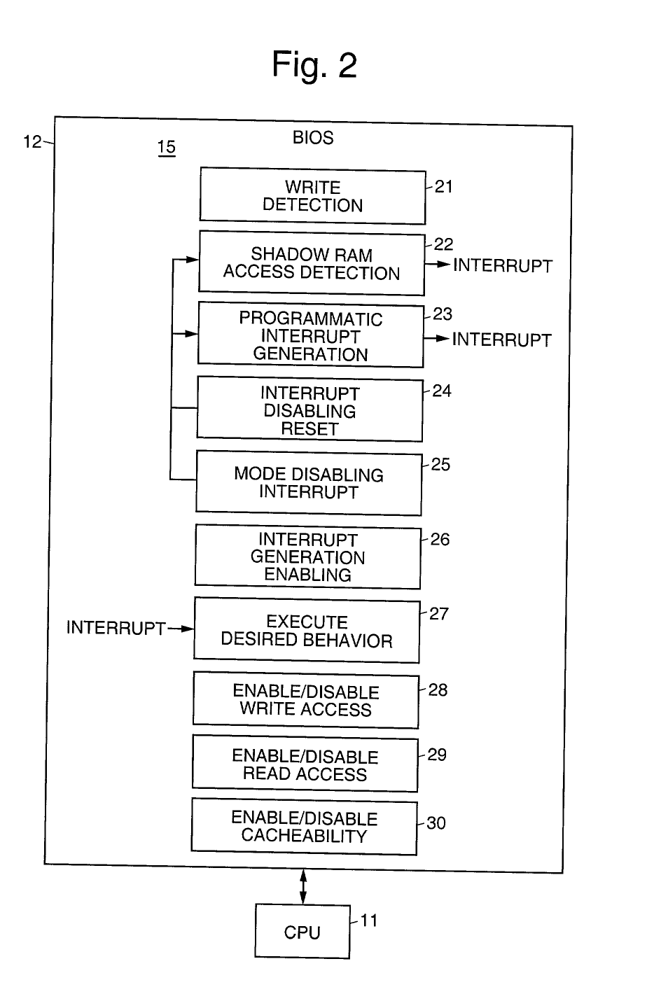

Components of the system firmware 15 or BIOS 15 that implement the present invention are depicted in FIG. 2. As is shown in FIG. 2, the firmware 15 or BIOS 15 includes logic 21 that detects attempts by a program that is executing on the CPU 11 to write to logic that modifies any of the three attributes (registers 13a) of the shadow RAM 13.

Logic 22 is provided that, upon detection of an attempt to access the shadow RAM 13 or a shadow RAM area 13a (or register 13a), generates an interrupt. The interrupt that is generated may be a system management interrupt (SMI), a non-maskable interrupt (NMI) or general-purpose interrupt, for example.

Means (or logic) 23, such as a configuration register, for example, is provided that enables programmatic generation of the interrupt. Means (or logic) 24, such as a reset or power button, chipset register or external device, such as a keyboard controller, for example, is provided that disables the interrupt using a reset signal sent to the interrupt generating logic 22. Means (or logic) 25, such as a configuration register, whose contents is AND'd with a signal indicating the CPU's operating mode, for example, is provided that disables generation of the interrupt while the CPU 11 is operating in one or more predetermined modes (such as system management mode (SMM), for example).

Logic 26 contained in the system firmware 15 is provided that, after all modifications to a shadow RAM area 13a (or register 13a) are complete, enables generation of the interrupt before initiating operating system code. Software (preferably firmware) 27 is provided that begins execution when the interrupt is generated and performs a desired behavior. Such behavior may include an security alert, remote administrator signaling, logging of an event, or ignoring of the event and resuming operation.

Optionally, logic 28 is provided in the system firmware 15 to programmatically enable and disable write access to a selected shadow RAM area 13a (or register 13a). This may be controlled using a configuration register, when located in memory space, input/output (I/O) address space, Peripheral Component Interconnect (PCI) address space, or other address space.

Optionally, logic 29 is provided in the system firmware 15 to programmatically enable and disable read access to a selected shadow RAM area 13a (or register 13a). This may be controlled using a configuration register, when located in memory space, I/O address space, PCI address space, or other available address space.

Optionally, logic 30 is provided in the system firmware 15 to programmatically enable and disable cacheability of a shadow RAM area 13a (or register 13a). This may be controlled using a configuration register, when located in memory space, I/O address space, PCI address space, or other available address space.

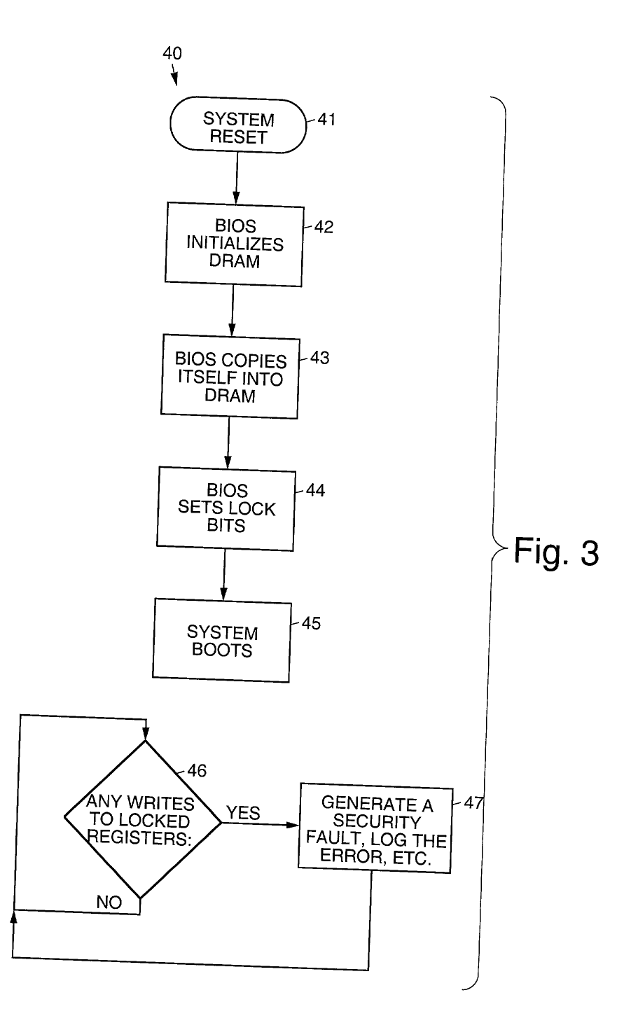

FIG. 3 is a flow diagram that illustrates an exemplary method 40 in accordance with the principles of the present invention for securing system firmware 15 located in shadow RAM 13 of a computer system 10. The exemplary method 40 is also exemplary of the software that is implemented by the present invention. The exemplary method 40 comprises the following steps.

The computer system 10 is reset 41 (or initially turned on). The BIOS 15 then initializes 42 the DRAM 12 including the shadow RAM 13. The BIOS 15 copies 43 itself into the shadow RAM 13. The BIOS then sets 44 LOCK bits associated with registers of the shadow RAM 13. The computer operating system then boots 45. The BIOS 15 then monitors 46 attempted writes to locked registers of the shadow RAM 13. If a write operation to a locked register is detected, the BIOS generates 47 an interrupt.

An alternative embodiment of the present invention may include more or fewer shadow RAM areas 13a, or register 13a, (more is preferred). Another embodiment of the present invention may include more or fewer LOCK bits. The number of LOCK bits equivalent to the number of shadow RAM areas 13a, or register 13a, is preferred. Yet another embodiment of the present invention may monitor different “reset” signals.

In yet another embodiment of the present invention, different points of execution within the power-on self-test (POST) code of the BIOS 15 may be chosen for asserting the LOCK bit. If security against attacks use “option ROMs”, then an earlier point during initialization of the BIOS 15 may be chosen. If the physical platform (computer) is assumed to be reasonably secure or provides no place for expansion cards, then the point can be significantly later in the power-on self-test (POST) process. The latter is generally preferred because it places fewer restrictions on the ability of the power-on self-test (POST) code to modify contents of shadow RAM 13.

Thus, a system, method and software for securing system firmware located in shadow RAM from unauthorized tampering have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. A system having secure system firmware, comprising:
a central processing unit (CPU);
a dynamic random access memory (DRAM) coupled to the CPU that comprises a shadow random access memory (RAM) including one or more registers whose attributes are separately configurable; and
system firmware that when the system is reset, initializes the DRAM and the shadow RAM, copies itself into the shadow RAM, sets LOCK bits associated with the registers of the shadow RAM, boots a computer operating system, monitors attempted writes to locked registers of the shadow RAM, and if a write operation to a locked register is detected, generates an interrupt that indicates an attempt to tamper with the system firmware.

2. The system recited in claim 1 wherein the interrupt that is generated is selected from a group consisting of a system management interrupt (SMI), a non-maskable interrupt (NMI) and a general-purpose interrupt.

3. The system recited in claim 1 wherein the system firmware enables generation of the interrupt before initiating operating system code and after all modifications to the shadow RAM are complete.

4. The system recited in claim 1 wherein the system firmware begins execution when the interrupt is generated and performs a desired behavior.

5. The system recited in claim 4 wherein the desired behavior includes an security alert, remote administrator signaling, logging of an event, or ignoring of the event and resuming operation.

6. The system recited in claim 1 wherein the system firmware is selectively configured to programmatically enable and disable write access to a selected shadow RAM register, programmatically enable and disable read access to a selected shadow RAM register, and programmatically enable and disable cacheability of a shadow RAM register.

7. A method for use with a computer system having a central processing unit (CPU), a dynamic random access memory (DRAM) coupled to the CPU that comprises a shadow random access memory (RAM) including one or more registers whose attributes are separately configurable, and system firmware that runs on the CPU, the method comprising the steps of:
initializing the DRAM and the shadow RAM;
copying itself into the shadow RAM;
setting LOCK bits associated with the registers of the shadow RAM;
booting a computer operating system;
monitors attempted writes to locked registers of the shadow RAM; and
if a write operation to a locked register is detected, generating an interrupt that indicates an attempt to tamper with the system firmware.

8. The method recited in claim 7 wherein the interrupt that is generated is selected from a group consisting of a system management interrupt (SMI), a non-maskable interrupt (NMI) and a general-purpose interrupt.

9. The method recited in claim 7 wherein the system firmware generates 47 the interrupt before initiating operating system code and after all modifications to the shadow RAM are complete.

10. The method recited in claim 7 wherein the system firmware begins execution when the interrupt is generated and performs a desired behavior.

11. The method recited in claim 10 wherein the desired behavior includes an security alert, remote administrator signaling, logging of an event, or ignoring of the event and resuming operation.

12. The method 40 recited in claim 7 wherein the system firmware is selectively configured to programmatically enable and disable write access to a selected shadow RAM register, programmatically enable and disable read access to a selected shadow RAM register, and programmatically enable and disable cacheability of a shadow RAM register.

13. Software for use with a computer system having a central processing unit (CPU), a dynamic random access memory (DRAM) coupled to the CPU that comprises a shadow random access memory (RAM) including one or more registers whose attributes are separately configurable, and system firmware that runs on the CPU, that comprises:
a code segment that initializes the DRAM and the shadow RAM;
a code segment that copies itself into the shadow RAM;
a code segment that sets LOCK bits associated with the registers of the shadow RAM;
a code segment that boots a computer operating system;
a code segment that monitors attempted writes to locked registers of the shadow RAM; and
a code segment that, if a write operation to a locked register is detected, generates an interrupt that indicates an attempt to tamper with the system firmware.

14. The software recited in claim 13 wherein the interrupt that is generated is selected from a group consisting of a system management interrupt (SMI), a non maskable interrupt (NMI) and a general-purpose interrupt.

15. The software recited in claim 13 wherein the interrupt generating code segment generates the interrupt before initiating operating system code and after all modifications to the shadow RAM are complete.

16. The software recited in claim 13 further comprising a code segment that begins execution when the interrupt is generated and performs a desired behavior.

17. The software recited in claim 16 wherein the desired behavior includes an security alert, remote administrator signaling, logging of an event, or ignoring of the event and resuming operation.

18. The software recited in claim 13 further comprising a code segment that programmatically enable and disable write access to a selected shadow RAM register.

19. The software recited in claim 13 further comprising a code segment that programmatically enables and disables read access to a selected shadow RAM register.

20. The software recited in claim 13 further comprising a code segment that programmatically enables and disables cacheability of a selected shadow RAM register.
